(19) United States
(12) Patent Application Publication
(10) Pub. No.: US 2024/0279782 A1
(43) Pub. Date: Aug. 22, 2024

(54) NON-ORIENTED SILICON STEEL AND METHOD FOR PRODUCING THE SAME

(71) Applicants: INSTITUTE OF RESEARCH OF IRON AND STEEL, JIANGSU PROVINCE/SHA-STEEL, CO. LTD, Suzhou (CN); ZHANGJIAGANG YANGTZE RIVER COLD ROLLED PLATE CO. LTD, Zhangjiagang City (CN); JIANGSU SHAGANG GROUP CO., LTD., Zhangjiagang City (CN)

(72) Inventors: Chongxiang YUE, Zhangjiagang City (CN); Jiadong LU, Zhangjiagang City (CN); Shengjie WU, Zhangjiagang City (CN); Hongwei QIAN, Zhangjiagang City (CN)

(21) Appl. No.: 18/570,323

(22) PCT Filed: Jul. 7, 2021
(86) PCT No.: PCT/CN2021/105008

§ 371 Date: Dec. 14, 2023

(30) Foreign Application Priority Data
Jun. 17, 2021 (CN) 202110670657.9

(51) Int. Cl. C22C 38/02; C21D 1/28; C21D 6/00; C21D 8/12; C22C 38/04

(52) U.S. Cl. CPC C22C 38/02; C21D 1/28; C21D 6/008; C21D 8/1205; C21D 8/1222; C21D 8/1272; C21D 8/1283; C22C 38/04

(57) ABSTRACT

The present application discloses a non-oriented silicon steel and a method for producing the same. The production method includes: carrying out steelmaking in accordance with 0.8-1.1% of Si and 0.2-0.4% of Mn, without the addition of Sn and Sb, and making a cast billet; heating the cast billet to 1060-1120° C., then rolling and finish rolling and coiling the cast billet into a hot rolled coil with a thickness of 3.00±0.25 mm, where the start-rolling temperature for finish rolling is ≤872° C.+1000*(11*[Si]−14*[Mn]+21*[Al]), the end-rolling temperature for finish rolling is ≤820° C., and the coiling temperature is ≤560° C.; normalizing and acid tandem rolling, where the normalizing temperature is 850-900° C.; and annealing at the temperature for final annealing of 820-880° C., cooling, coating and finishing are carried out to obtain the non-oriented silicon steel.

### CROSS-REFERENCE TO RELATED APPLICATIONS

This application claims priority to Chinese Patent Application No. 202110670657.9, filed on Jun. 17, 2021, entitled “NON-ORIENTED SILICON STEEL AND METHOD FOR PRODUCING THE SAME,” the entire content of which is incorporated herein by reference.

### TECHNICAL FIELD

The present invention belongs to the technical field of steel and iron material preparation, relating to a non-oriented silicon steel and a method for producing the same.

### BACKGROUND

Non-oriented silicon steel is a core material for electric motors and generator rotors working in rotating magnetic field, and its quality stability is of great significance for quality improvement of electric motors. In medium and low-grade non-oriented silicon steel, the content of Si is controlled to be 0.5%-1.7%. An existing common production process route is generally steelmaking-billet casting-hot rolling-acid tandem rolling-annealing-coating and finishing. In the hot rolling process, obtained is equiaxed ferrite+deformed ferrite. The rolling temperature and coiling temperature have great effect on the ferrite grain size and the proportion of equiaxed ferrite in the hot rolling process. Due to the fast heat dissipation at the head and tail of a hot rolled coil, the rolling temperature and the coiling temperature at the head and tail of the hot rolled coil are lower than that of the middle of the hot rolled coil. This further leads to small ferrite grains and high proportion of deformed ferrite of the head and tail compared to that of the middle. Eventually, the head and tail of a finished coil of the non-oriented silicon steel have high iron loss and low magnetic induction intensity. Therefore, there is a problem of inconsistent magnetic properties of the entire coil.

In order to solve the problem of inconsistent magnetic properties of the entire coil of medium and low-grade non-oriented silicon steel, a current method to deal with this problem is mainly to anneal the head and tail at reduced production speed. That is, in the annealing process, the roll speed at which the head and tail of the steel coil are annealed is smaller than the roll speed at which the middle of the steel coil is annealed, hoping to improve the consistency of magnetic properties of the entire coil through the annealing. However, this method results in the adjustment of roll speed during production, which increases the production difficulty, reduces the production efficiency, and increases the production cost of the annealing process.

### SUMMARY

In view of the problems in the prior art, an object of the present invention is to provide a non-oriented silicon steel and a method for producing the same, which solves the problem of inconsistent magnetic properties of the entire coil of the non-oriented silicon steel without significantly increasing the production cost and meeting the requirements of small and medium-sized electric motors for medium and low-grade non-oriented silicon steel.

For achieving the object above, an embodiment of the present invention provides a non-oriented silicon steel, including the following chemical composition in percentage by mass: C≤0.004%, S≤0.004%, Si: 0.8-1.1%, Mn: 0.2-0.4%, P<0.03%, Nb≤0.004%, V≤0.006%, Ti≤0.005%, Cr≤0.03%, Ni≤0.03%, Cu≤0.03%, N≤0.004%, Al: 0.15-0.30% or Al≤0.02%, and the balance of Fe and unavoidable inclusions, where the non-oriented silicon steel has a thickness of 0.500±0.005 mm and is prepared by sequential steelmaking, billet casting, hot rolling, normalizing, acid tandem rolling, final annealing, cooling, coating and finishing:
Sn and Sb are not added in the steelmaking process;
in the hot rolling process: a cast billet obtained from the billet casting process is heated to 1060-1120° C. and held for 150 min or more, and then rolled into an intermediate billet with a thickness of 40-45 mm, and then the intermediate billet is finish rolled and coiled into a hot rolled coil with a thickness of 3.00±0.25 mm, where the start-rolling temperature for finish rolling is ≤ Ar1=872° C.+1000*(11*[Si]−14*[Mn]+21*[Al]), in the formula, [Si], [Mn] and [Al] are mass percentages of Si, Mn and Al in the cast billet, respectively: the end-rolling temperature for finish rolling is ≤820° C., and the coiling temperature is ≤560° C.;
in the normalizing process, the normalizing temperature is 850-900° C.; and in the final annealing process, the production is carried out at a constant speed and the annealing temperature is 820-880° C.

Preferably, the iron loss P_{1.5/50} of the non-oriented silicon steel is ≤4.2 W/kg, the fluctuation of iron loss P_{1.5/50} of the head, middle and tail is ≤0.2 W/kg, the magnetic induction intensity B₅₀₀₀ is ≥1.72 T and the fluctuation of magnetic induction intensity B₅₀₀₀ of the head, middle and tail is ≤0.02 T.

Preferably, in the normalizing process, the normalizing is carried out in a pure dry N₂ atmosphere for 120-150 s.

Preferably, in the normalizing process, the normalizing temperature fluctuates by ±10° C. and the production is carried out at a constant speed.

Preferably, in the annealing process, the annealing time is 50±5 s, the annealing temperature fluctuates by ±10° C., and the production is carried out at a constant speed.

For achieving the object above, an embodiment of the present invention provides a method for producing a non-oriented silicon steel, including the following steps:
(1) carrying out steelmaking without the addition of Sn and Sb and preparing a cast billet, the cast billet including the following chemical composition in percentage by mass: C≤0.004%, S≤0.004%, Si: 0.8-1.1%, Mn: 0.2-0.4%, P≤0.03%, Nb≤0.004%, V≤0.006%, Ti≤0.005%, Cr≤0.03%, Ni≤0.03%, Cu≤0.03%, N≤0.004%, Al: 0.15-0.30% or Al≤0.02%, and the balance of Fe and unavoidable inclusions;
(2) heating the cast billet to 1060-1120° C. and holding for 150 min or more, then rolling the cast billet into an intermediate billet with a thickness of 40-45 mm, and then finish rolling and coiling the intermediate billet into a hot rolled coil with a thickness of 3.00±0.25 mm, where the start-rolling temperature for finish rolling is ≤ Ar1=872° C.+1000*(11*[Si]−14*[Mn]+21*[Al]), in the formula, [Si], [Mn] and [Al] are mass percentages of Si, Mn and Al in the cast billet, respectively: the end-rolling temperature for finish rolling is ≤820° C., and the coiling temperature is ≤560° C.;
(3) normalizing and acid tandem rolling the hot rolled coil in sequence to obtain a chilled coil with a thickness of 0.500±0.005 mm, where the normalizing temperature is 850-900° C.; and
(4) carrying out final annealing for the chilled coil in a continuous annealing furnace at a constant speed in a mixed atmosphere of H₂+N₂ at the temperature for final annealing of 820-880° C.; and cooling, coating and finishing the annealed steel strip to obtain the non-oriented silicon steel.

Preferably, in step 3, the normalizing is carried out in a pure dry N₂ atmosphere for 120-150 s.

Preferably, in step 3, the normalizing temperature fluctuates by #10° C. and the production is carried out at a constant speed.

Preferably, in step 4, the annealing time is 50±5s, the annealing temperature fluctuates by ±10° C., and the production is carried out at a constant speed.

Preferably, the iron loss P_{1.5/50} of the non-oriented silicon steel is ≤4.2 W/kg, the fluctuation of iron loss P_{1.5} so of the head, middle and tail is ≤0.2 W/kg, the magnetic induction intensity B₅₀₀₀ is ≥1.72 T and the fluctuation of magnetic induction intensity B₅₀₀₀ of the head, middle and tail is ≤0.02 T.

For achieving the object above, an embodiment of the present invention provides a method for producing a non-oriented silicon steel, including the following steps:
(1) carrying out steelmaking in accordance with a chemical composition of 0.8-1.1% of Si in percentage by mass and 0.2-0.4% of Mn in percentage by mass, without adding Sn and Sb during the steelmaking, and preparing a cast billet;
(2) heating the cast billet to 1060-1120° C. and holding for 150 min or more, then rolling the cast billet into an intermediate billet with a thickness of 40-45 mm, and then finish rolling and coiling the intermediate billet into a hot rolled coil with a thickness of 3.00±0.25 mm, where the start-rolling temperature for finish rolling is ≤ Ar1=872° C.+1000*(11*[Si]−14*[Mn]+21*[Al]), in the formula, [Si], [Mn] and [Al] are mass percentages of Si, Mn and Al in the cast billet, respectively: the end-rolling temperature for finish rolling is ≤820° C., and the coiling temperature is ≤560° C.;
(3) normalizing and acid tandem rolling the hot rolled coil in sequence to obtain a chilled coil with a thickness of 0.500±0.005 mm, where the normalizing temperature is 850-900° C.; and
(4) carrying out final annealing for the chilled coil in a continuous annealing furnace at a constant speed in a mixed atmosphere of H₂+N₂ at the temperature for final annealing of 820-880° C.; and cooling, coating and finishing the annealed steel strip to obtain the non-oriented silicon steel.

Compared with the prior art, the present invention has the following beneficial effects:
(1) The finished product of the non-oriented silicon steel with a thickness of 0.500±0.005 mm prepared by the production method has iron loss of P_{1.5/50}≤4.2 W/kg, magnetic induction intensity B₅₀₀₀≥1.72 T, and excellent magnetic properties, basically the same as that of the existing non-oriented silicon steel with an Si content of 1.4-1.7%, and thus is able to meet the demand of small and medium-sized electric motors for medium and low-grade non-oriented silicon steel. Moreover, the magnetic properties of the entire coil are consistent, the fluctuation of iron loss P_{1.5/50} is ≤0.2 W/kg, and the fluctuation of magnetic induction intensity B₅₀₀₀ is ≤0.02 T.
(2) By adopting low-temperature rolling and low-temperature coiling processes in the hot rolling process, the hot rolled coil with a completely deformed ferrite structure is obtained, and in combination with the normalizing process, it is ensured that the final non-oriented silicon steel has better magnetic property, and in the case of production at a constant speed in the final annealing process, the problem of inconsistent magnetic properties of the head, middle and tail of the finished product of the non-oriented silicon steel in the prior art is solved, and abnormal growth of grains on surface in comparison with the interior of the steel coil during the normalizing is avoided.
(3) In spite of the addition of the normalizing process, the production cost is not increased, and high economic value is obtained with low cost. Specifically, the combination of the hot rolling process and the normalizing process gives full play to the improvement effect of the normalizing process on the structure of non-oriented silicon steel hot rolled steel plate and the magnetic properties of the finished product, reduces the production costs of the steelmaking, hot rolling, acid tandem rolling, normalizing and annealing processes, and ensures that the cost of the entire process is not increased. In the steelmaking process, in terms of the chemical composition, the content of Si element to improve magnetic properties is reduced from 1.4-1.7% to 0.8-1.1%, the precious metals Sn and Sb to improve magnetic properties are no longer added, and the addition of Mn element is reduced, which reduces the cost of steelmaking alloy while obtaining the same magnetic properties as those of an existing chemical composition. In the hot rolling process, the low-temperature rolling and low-temperature coiling processes are used, on the one hand, the temperature requirements for a heating furnace are reduced, and with low-temperature heating, energy consumption and production cost are reduced compared with an existing hot rolling process; and on the other hand, the scale on the surface of the hot rolled coil is reduced, the burning loss is decreased, the yield is improved, and the production cost is reduced. In addition, the thickness of the hot rolled coil is increased from 2.0-2.5 mm to 3.00±0.25 mm, the production rate of the hot rolling process is improved, and the overall production cost of the hot rolling process is reduced. In the normalizing process, since the hot rolling uses the low-temperature rolling and low-temperature coiling processes, the internal distortion energy of the hot rolled coil is increased in comparison with the conventional high-temperature rolling and high-temperature coiling, the normalizing difficulty is reduced, and low-temperature and high-speed production can be realized in the normalizing process; and in addition, the thickness of the hot rolled coils is increased from 2.0-2.5 mm to 3.00±0.25 mm, the production rate of the normalizing process is improved, and the overall production cost of the normalizing process is reduced. In the acid tandem rolling process, since the hot rolling uses the low-temperature rolling and low-temperature coiling processes, the scale on the surface of the steel plate is easier to be removed in the acid tandem rolling process in comparison with the prior art, which reduces the pickling difficulty in the acid tandem rolling, and improves the surface quality of products and the production rate accordingly; and the thickness of the hot rolled coil is increased from 2.0-2.5 mm to 3.00±0.25 mm, the production rate of the acid tandem rolling process is improved, and the overall production cost of the acid tandem rolling process is reduced. In the annealing process, due to the combination of the hot rolling process and the normalizing process, the resulting steel coil has a uniform structure in the head, middle and tail, such that the annealing process can use constant-speed and low-temperature production, which reduces the production difficulty, improves the production efficiency, and thus reduces the production cost.

### BRIEF DESCRIPTION OF THE DRAWINGS

FIG. 1 is a photograph of metallographic structure of a hot rolled coil in Comparative Example 1 obtained by microscopical metallography;

FIG. 2 is a photograph of metallographic structure of a hot rolled coil in Comparative Example 2 obtained by microscopical metallography:

FIG. 3 is a photograph of metallographic structure of a hot rolled coil in Comparative Example 3 obtained by microscopical metallography:

FIG. 4 is a photograph of metallographic structure of a hot rolled coil in Example 1 obtained by microscopical metallography:

FIG. 5 is a photograph of metallographic structure of a hot rolled coil in Example 2 obtained by microscopical metallography; and

FIG. 6 is a photograph of metallographic structure of the hot rolled coil in Example 2 after a normalizing process obtained by microscopical metallography.

### DETAILED DESCRIPTION

An embodiment of present invention provides a non-oriented silicon steel and a method for producing the same. The non-oriented silicon steel has a chemical composition with an Si content of 0.8-1.1% in percentage by mass and an Mn content of 0.2-0.4% in percentage by mass, and is prepared by sequential steelmaking, billet casting, hot rolling, normalizing, acid tandem rolling, final annealing, cooling, coating and finishing. That is, the production method includes the sequential processes of steelmaking, billet casting, hot rolling, normalizing, acid tandem rolling, final annealing, cooling, coating and finishing. The production method is described in detail below in accordance with the following steps.

(1) steelmaking is carried out in accordance with a chemical composition of 0.8-1.1% of Si in percentage by mass and 0.2-0.4% of Mn in percentage by mass, without adding Sn and Sb during the steelmaking, and a cast billet is prepared.

Step 1 is also the steelmaking process and the billet casting process.

The steelmaking process may include molten iron desulfurization, converter smelting, RH refining, and other processes in sequence, which may be implemented using existing feasible process means without further elaboration. Steelmaking is carried out in accordance with the chemical composition of 0.8-1.1% of Si in percentage by mass and 0.2-0.4% of Mn in percentage by mass and during the steelmaking, Sn and Sb are not added, and accordingly, the resulting cast billet and the final non-oriented silicon steel have 0.8-1.1% of Si in percentage by mass and 0.2-0.4% of Mn in percentage by mass in the chemical composition, without Sn and Sb.

In an embodiment, the resulting cast billet and the final non-oriented silicon steel include the following chemical composition in percentage by mass: C≤0.004%, S≤0.004%, Si: 0.8-1.1%, Mn: 0.2-0.4%, P≤0.03%, Nb≤0.004%, V≤0.006%, Ti≤0.005%, Cr≤0.03%, Ni≤ 0.03%, Cu≤0.03%, N≤0.004%, Al: 0.15-0.30%, and the balance of Fe and unavoidable inclusions. Alternatively, in another embodiment, the resulting cast billet and the final non-oriented silicon steel include the following chemical composition in percentage by mass: C≤ 0.004%, S≤0.004%, Si: 0.8-1.1%, Mn: 0.2-0.4%, P≤0.03%, Nb≤0.004%, V≤0.006%, Ti≤ 0.005%, Cr≤0.03%, Ni≤0.03%, Cu≤0.03%, N≤0.004%, Al≤0.02%, and the balance of Fe and unavoidable inclusions.

Preferably, the cast billet obtained in step 1 has a thickness of ≥200 mm and a length of 10-11 m.

Step 2: the cast billet obtained in step 1 is heated to 1060-1120° C. and held for 150 min or more, then rolled into an intermediate billet with a thickness of 40-45 mm, and then the intermediate billet is finish rolled and coiled into a hot rolled coil with a thickness of 3.00±0.25 mm.

Step 2 is also the hot rolling process. The start-rolling temperature for finish rolling is ≤ Aᵣ₁=872° C.+1000*(11*[Si]−14*[Mn]+21*[Al]), in the formula, [Si], [Mn] and [Al] are mass percentages of Si, Mn and Al in the cast billet obtained in step 1, respectively. That is, Aᵣ₁ is calculated from the mass percentages [Si], [Mn], and [Al] of Si, Mn, and Al in the cast billet obtained in step 1, Aᵣ₁=872° C.+1000*(11*[Si]−14*[Mn]+21*[Al]), and in step 2, the start-rolling temperature for finish rolling is controlled to be less than or equal to Aᵣ₁. Moreover, the end-rolling temperature for finish rolling is controlled to be ≤820° C., and the coiling temperature is controlled to be ≤560° C.

In this way, in this embodiment, the hot rolling process uses low-temperature rolling and low-temperature coiling processes, to ensure that all passes in the finish rolling are carried out in a ferrite zone, and the final pass in the finish rolling is carried out in a low-temperature ferrite zone. In this way, there is no y/a phase transition in the finish rolling process, the resulting hot rolled coil is of a single-phase structure of completely deformed ferrite, and based on this structure, in the case of different dissipation rates at the head, middle and tail, the structure uniformity of the hot rolled coil can still be ensured, and furthermore, a foundation is laid for obtaining a finished product of the non-oriented silicon steel with consistent magnetic properties of the entire coil subsequently.

In addition, in this embodiment, the hot rolling process uses the low-temperature rolling and low-temperature coiling processes, which reduces the temperature requirements for a heating furnace, with low-temperature heating, solid solutions of precipitates in the cast billet are reduced, which is conducive to the growth of grains in the structure, which in turn ensures that the subsequent resulting finished product of the non-oriented silicon steel has excellent magnetic properties, and the production cost is reduced in comparison with an existing hot rolling process.

Step 3: The hot rolled coil obtained in step 2 is normalized and acid tandem rolled in sequence to obtain a chilled coil with a thickness of 0.500±0.005 mm, where the normalizing temperature is 850-900° C.

Step 3 is also the normalizing process and the acid tandem rolling process.

The normalizing process is generally applied in the production of high-grade non-oriented silicon steel. That is, the production process route of the high-grade non-oriented silicon steel is steelmaking, billet casting, hot rolling, normalizing, acid tandem rolling, annealing, coating and finishing. However, for existing production methods of medium and low-grade non-oriented silicon steel, if the normalizing process is added as in the case of high-grade non-oriented silicon steel, although it can improve the inconsistency of the magnetic properties of the head, middle and tail to a certain degree, it will lead to abnormal growth of grains on surface in comparison with the interior of the hot rolled coil, resulting in serious color difference on the surface of the steel coil after the acid tandem rolling, and increasing the production cost. In the production method of the present invention, by using the low-temperature rolling and low-temperature coiling processes in the aforementioned step 2 of the hot rolling process, the hot rolled coil with completely deformed ferrite structure is obtained, laying a foundation for the normalizing process, avoiding the problem of abnormal growth of grains on the surface in comparison with the interior of the steel coil as described above in the existing normalizing process. i.e., enabling the grains of the steel coil after the normalizing process to be uniformly grown in all places. Moreover, the normalizing process can also ensure that the final non-oriented silicon steel has better magnetic properties. Furthermore, the completely deformed ferrite structure of the hot rolled coil accumulates very high storage energy, which can reduce the normalizing difficulty and achieve low-temperature and high-speed production in the normalizing process, thus avoiding an excessive increase in production cost due to the addition of the normalizing process. In addition, due to the smooth implementation of the normalizing process, the magnetic properties of the final non-oriented silicon steel can be greatly improved. In this case, in terms of the chemical composition of the present invention, the content of the Si element to improve magnetic properties is reduced from 1.4-1.7% to 0.8-1.1%, the precious metals Sn and Sb to improve magnetic properties are no longer added, and the addition of the Mn element is reduced, so that it is possible to obtain the same magnetic properties as in the existing chemical composition, and the cost of alloy can be reduced.

Further preferably, in the normalizing process, the normalizing is carried out in a pure dry N₂ atmosphere for 120-150 s. In addition, preferably, in the normalizing process, the normalizing temperature fluctuates by ±10° C. i.e., the normalizing temperature is controlled in a fluctuation range of #10° C. so that the difference between the maximum and minimum temperature values during the normalizing does not exceed 20°. Moreover, in the normalizing process, the production is carried out at a constant speed. i.e., the roll speed is constant when normalizing is carried out for the head, middle, and tail of the steel coil.

Moreover, in this embodiment, by adopting the low-temperature heating, low-temperature rolling, and low-temperature coiling processes in the hot rolling process of step 2, the scale on surface of the hot rolled coil is reduced, and the burning loss is reduced. This in turn makes the scale on the surface of the steel plate easier to be removed in the acid tandem rolling process of step 3 in comparison with the prior art, which reduces the pickling difficulty in the acid tandem rolling, and improves the surface quality of products and the production rate accordingly. In addition, as described above, by adopting the low-temperature heating in the hot rolling process of step 2, it is conducive to the growth of grains in the structure, and in combination with the addition of the normalizing process, the thickness of the hot rolled coil in step 2 can be increased from 2.0-2.5 mm to 3.00±0.25 mm. Moreover, the greater the thickness of the hot rolled coil, the greater the amount of steel that can be pickled through the pickling process of the acid tandem rolling process of step 3 at the same roll speed. This in turn increases the production rate of the acid tandem rolling process and reduces the overall production cost of the acid tandem rolling process.

In addition, as described above, due to the combination of low-temperature heating in the hot rolling process and the normalizing process, the thickness of the hot rolled coil can be increased from 2.0-2.5 mm to 3.00±0.25 mm, and the increase in the thickness of the hot rolled coil can in turn greatly reduce the difficulty of hot rolling in the hot rolling process, and enhance the production efficiency of the hot rolling process.

Further preferably, in the acid tandem rolling process of step 3, three-stage pickling is carried out with HCl first, and then rinsing, drying and cold rolling are carried out to obtain a chilled coil.

Step 4: the chilled coil obtained in step 3 is subjected to final annealing in a continuous annealing furnace at a constant speed in a mixed atmosphere of H₂+N₂ at the temperature for final annealing of 820-880° C.; and the annealed steel strip is subjected to cooling, coating and finishing to obtain the finished product of the non-oriented silicon steel.

Step 4 is also the final annealing process, the cooling process, the coating process and finishing process.

In this embodiment, it can be seen from the foregoing that, based on the hot rolling process of step 2 and the normalizing process of step 3, the resulting steel coil is uniform in structure at the head, middle and tail. Then the final annealing process in step 4 uses low-temperature and constant-speed production. Then through the conventional cooling, coating, and finishing, the non-oriented silicon steel with excellent magnetic properties that are consistent at the head, middle and tail and a thickness of 0.500±0.005 mm can be obtained. There is no need to anneal head and tail at reduced production speed as in the prior art, which reduces the production difficulty and improves the production efficiency.

The constant speed production of the final annealing process is also constant speed production in the final annealing process, and is also a constant roll speed when annealing the head, middle, and tail of the steel coil.

Further preferably, in the final annealing process of step 4, the annealing time is 50±5 s, and the final annealing temperature fluctuates by #10° C., i.e., the difference between the maximum and minimum temperature values in the annealing process of the finished product does not exceed 20°.

Further preferably, in the cooling process of step 4, three-stage cooling is used to cool the steel strip after the final annealing, effectively controlling the residual stress of the steel strip to be ≤50 MPa, which is beneficial for the control of plate shape.

The non-oriented silicon steel of an embodiment of the present invention is prepared using the production method described above. The non-oriented silicon steel has a thickness of 0.500±0.005 mm, and, as previously described, has the following chemical composition in percentage by mass: C≤0.004%, S≤0.004%, Si: 0.8-1.1%, Mn: 0.2-0.4%, P≤0.03%, Nb≤ 0.004%, V≤0.006%, Ti≤0.005%, Cr≤0.03%, Ni≤0.03%, Cu≤0.03%, N≤0.004%, Al: 0.15-0.30% or Al≤0.02%, and the balance of Fe and unavoidable inclusions;

The non-oriented silicon steel has iron loss of P_{1.5/50}≤4.2 W/kg, magnetic induction intensity B₅₀₀₀≥1.72 T, and excellent magnetic properties, basically the same as that of the existing non-oriented silicon steel with an Si content of 1.4-1.7%, and thus can meet the demand of small and medium-sized electric motors for medium and low-grade non-oriented silicon steel. Moreover, the magnetic properties of the entire coil are consistent, the fluctuation of iron loss P_{1.5/50} is ≤0.2 W/kg, and the fluctuation of the magnetic induction intensity B₅₀₀₀ is ≤0.02 T. That is, the difference between the maximum and minimum values of iron loss P_{1.5/50} of the head, middle and tail of the finished steel coil of the non-oriented silicon steel is ≤0.2 W/kg, and the difference between the maximum and minimum values of B₅₀₀₀ at the head, middle and tail is ≤0.02 T.

Compared with the prior art, the present invention has the following beneficial effects:
(1) The non-oriented silicon steel prepared by the production method has excellent magnetic properties, and can meet the demand of small and medium-sized electric motors for medium and low-grade non-oriented silicon steel. Moreover, the magnetic properties of the entire coil are consistent, the fluctuation of iron loss P_{1.5/50} and the fluctuation of magnetic induction intensity B₅₀₀₀ at the head, middle and tail are small, which enhances the stability of magnetic properties of the finished product of the non-oriented silicon steel.
(2) By adopting low-temperature rolling and low-temperature coiling processes in the hot rolling process, the hot rolled coil with a completely deformed ferrite structure is obtained, and in combination with the normalizing process, it is ensured that the final non-oriented silicon steel has better magnetic property, and in the case of production at a constant speed in the final annealing process, the problem of inconsistent magnetic properties of the head, middle and tail of the finished product of the non-oriented silicon steel in the prior art is solved, and abnormal growth of grains on surface in comparison with the interior of the steel coil during the normalizing is avoided.
(3) In spite of the addition of the normalizing process, the production cost is not increased, and high economic value is obtained with low cost. Specifically, the combination of the hot rolling process and the normalizing process gives full play to the improvement effect of the normalizing process on the structure of non-oriented silicon steel hot rolled steel plate and the magnetic properties of the finished product, reduces the production costs of the steelmaking, hot rolling, acid tandem rolling, normalizing and annealing processes, and ensures that the cost of the entire process is not increased. In the steelmaking process, in terms of the chemical composition, the content of Si element to improve magnetic properties is reduced from 1.4-1.7% to 0.8-1.1%, the precious metals Sn and Sb to improve magnetic properties are no longer added, and the addition of Mn element is reduced, which reduces the cost of steelmaking alloy while obtaining the same magnetic properties as those of an existing chemical composition. In the hot rolling process, the low-temperature rolling and low-temperature coiling processes are used, on the one hand, the temperature requirements for a heating furnace are reduced, and with low-temperature heating, energy consumption and production cost are reduced compared with an existing hot rolling process; and on the other hand, the scale on the surface of the hot rolled coil is reduced, the burning loss is decreased, the yield is improved, and the production cost is reduced. In addition, the thickness of the hot rolled coil is increased from 2.0-2.5 mm to 3.00±0.25 mm, the production rate of the hot rolling process is improved, and the overall production cost of the hot rolling process is reduced. In the normalizing process, since the hot rolling uses the low-temperature rolling and low-temperature coiling processes, the internal distortion energy of the hot rolled coil is increased in comparison with the conventional high-temperature rolling and high-temperature coiling, the normalizing difficulty is reduced, and low-temperature and high-speed production can be realized in the normalizing process; and in addition, the thickness of the hot rolled coils is increased from 2.0-2.5 mm to 3.00±0.25 mm, the production rate of the normalizing process is improved, and the overall production cost of the normalizing process is reduced. In the acid tandem rolling process, since the hot rolling uses the low-temperature rolling and low-temperature coiling processes, the scale on the surface of the steel plate is easier to be removed in the acid tandem rolling process in comparison with the prior art, which reduces the pickling difficulty in the acid tandem rolling, and improves the surface quality of products and the production rate accordingly; and the thickness of the hot rolled coil is increased from 2.0-2.5 mm to 3.00±0.25 mm, the production rate of the acid tandem rolling process is improved, and the overall production cost of the acid tandem rolling process is reduced. In the annealing process, due to the combination of the hot rolling process and the normalizing process, the resulting steel coil has a uniform structure in the head, middle and tail, such that the annealing process can use constant-speed and low-temperature production, which reduces the production difficulty, improves the production efficiency, and thus reduces the production cost.

The detailed descriptions listed above are only specific descriptions for feasible embodiments of the present invention and are not intended to limit the scope of protection of the present invention, and any equivalent embodiments or changes made without departing from the spirit of the art of the present invention shall be included in the scope of protection of the present invention.

The following three Comparative Examples and two Examples are used to further illustrate the beneficial effects of the present invention, of course, these two Examples are only some of the many variable examples contained in the present invention, but not all of them. The three Comparative Examples and two Example each provide a non-oriented silicon steel, the method for producing the same is specifically as follows.

### Step 1

Steelmaking was carried out, and then a cast billet was prepared. The chemical composition of the cast billet is shown in Table 1 in percentage by mass, the thickness of the cast billet is also shown in Table 1, and the length is 10-11 m.

TABLE 1

| | Chemical composition (%) | | | | | | | | | | | | | | Thickness |
|---|---|---|---|---|---|---|---|---|---|---|---|---|---|---|---|
| | C | S | Si | Mn | P | Sn | Nb | V | Ti | Cr | Ni | Cu | Al | N | (mm) |
| Comparative | 0.0025 | 0.0032 | 0.96 | 0.42 | 0.02 | 0.018 | 0.001 | 0.002 | 0.002 | 0.02 | 0.02 | 0.02 | 0.33 | 0.003 | 220 |
| Example 1 | | | | | | | | | | | | | | | |
| Comparative | 0.0023 | 0.0026 | 0.93 | 0.45 | 0.02 | 0.021 | 0.001 | 0.002 | 0.002 | 0.02 | 0.02 | 0.02 | 0.35 | 0.003 | 220 |
| Example 2 | | | | | | | | | | | | | | | |
| Comparative | 0.0024 | 0.0025 | 1.54 | 0.44 | 0.02 | 0.025 | 0.001 | 0.002 | 0.002 | 0.02 | 0.02 | 0.02 | 0.34 | 0.003 | 220 |
| Example 3 | | | | | | | | | | | | | | | |
| Example 1 | 0.0027 | 0.0028 | 0.94 | 0.35 | 0.02 | 0.001 | 0.001 | 0.002 | 0.002 | 0.02 | 0.02 | 0.02 | 0.01 | 0.003 | 220 |
| Example 2 | 0.0026 | 0.0026 | 1.05 | 0.31 | 0.02 | 0.001 | 0.001 | 0.002 | 0.002 | 0.02 | 0.02 | 0.02 | 0.26 | 0.003 | 220 |

### Step 2

The cast billet obtained in step 1 was heated and then rolled into an intermediate billet, and then the intermediate billet was finish rolled and coiled into a hot rolled coil. In Example 1 and Example 2, Aᵣ₁=872° C.+1000*(11*[Si]−14*[Mn]+21*[Al]) was calculated from the mass percentages [Si], [Mn] and [Al] of Si, Mn, and Al in the cast billet obtained in step 1. In step 2, the start-rolling temperature for finish rolling is less than or equal to Art. The end-rolling temperature for finish rolling was controlled to be ≤820° C. and the coiling temperature was controlled to be ≤560° C. to obtain a completely deformed structure. Whereas, conventional high-temperature end-rolling and high-temperature coiling processes are used in Comparative Examples 1-3 to obtain as much recrystallized structures as possible.

The heating temperature, the holding duration, the thickness of intermediate billet, the start-rolling temperature for finish rolling, the end-rolling temperature for finish rolling, the coiling temperature, and the thickness of hot rolled coil in Comparative Examples 1-3 and Examples 1-2 are shown in Table 2.

TABLE 2

| | | | | Start-rolling | End-rolling | | Thickness |
|---|---|---|---|---|---|---|---|
| | | | Thickness of | temperature | temperature | | of hot |
| | Heating | Holding | intermediate | for finish | for finish | Coiling | rolled |
| | temperature | duration | billet | rolling | rolling | temperature | coil |
| | (° C.) | (min) | (mm) | (° C.) | (° C.) | (° C.) | (mm) |
| Comparative | 1150 | 195 | 35 | 960 | 865 | 650 | 2.50 |
| Example 1 | | | | | | | |
| Comparative | 1150 | 190 | 35 | 960 | 865 | 650 | 2.50 |
| Example 2 | | | | | | | |
| Comparative | 1150 | 193 | 35 | 980 | 875 | 650 | 2.50 |
| Example 3 | | | | | | | |
| Example 1 | 1110 | 196 | 43 | 910 | 800 | 530 | 3.00 |
| Example 2 | 1110 | 190 | 43 | 930 | 800 | 530 | 3.00 |

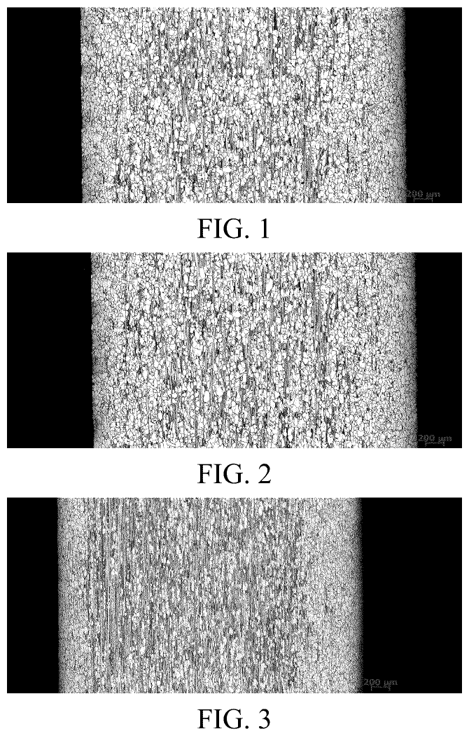

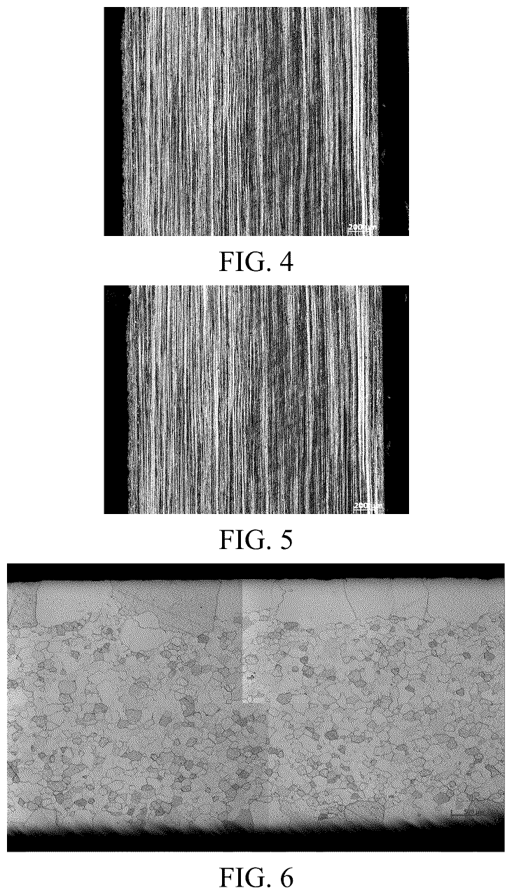

The hot rolled coils obtained in Comparative Examples 1-3 and Examples 1-2 were respectively subjected to microscopical metallography. The results obtained are shown in FIG. 1 to FIG. 5. It can be seen that the structures of Comparative Examples 1-3 are composite structures of deformed ferrite and equiaxed ferrite; and the structures of Examples 1-2 are structures of completely deformed ferrite without equiaxed ferrite structures.

### Step 3

The hot rolled coils obtained in Comparative Examples 1 and 3 of step 2 were directly subjected to acid tandem rolling to obtain chilled coils with a thickness of 0.500±0.005 mm; and the hot rolled coils obtained in Comparative Example 2 and Examples 1-2 of step 2 were subjected to normalizing and acid tandem rolling in sequence to obtain chilled coils with a thickness of 0.500±0.005 mm, where the normalizing was carried out in a pure dry N₂ atmosphere, and the normalizing temperature was 850-900° C.

Specifically, the key parameters of the Comparative Examples and Examples, such as the normalizing temperature, the normalizing duration, the fluctuation of normalizing temperature, the pickling rate, the thickness of chilled coil and the thickness of raw material, are shown in Table 3.

TABLE 3

| | | | Fluctuation | | | Thickness of |
|---|---|---|---|---|---|---|
| | Normalizing | Normalizing | of normalizing | Pickling | Thickness of | cold rolling |
| | temperature | duration | temperature | rate | chilled coil | material (hot |
| | (° C.) | (s) | (° C.) | (m/min) | (mm) | rolled coil) |
| Comparative | No normalizing | | | 170 | 0.50 | 2.50 |
| Example 1 | | | | | | |
| Comparative | 880 | 140 | +10 | 170 | 0.50 | 2.50 |
| Example 2 | | | | | | |
| Comparative | No normalizing | | | 170 | 0.50 | 2.50 |
| Example 3 | | | | | | |
| Example 1 | 880 | 140 | +10 | 170 | 0.50 | 3.00 |
| Example 2 | 880 | 140 | +10 | 170 | 0.50 | 3.00 |

The hot rolled coils obtained after the normalizing process in Comparative Example 2 and Examples 1-2 were respectively subjected to microscopical metallography. It can be seen from the results of Comparative Example 2 in FIG. 6 that there Is abnormal growth of grains on the surface of the hot rolled coil of Comparative Example 2 after the normalizing process; whereas, the structures of the hot rolled coils obtained in Examples 1-2 after the normalizing process are completely equiaxed ferrite structures, which are uniform structures.

In addition, in Comparative Examples 1-3 and Examples 1-2, the surface quality of the chilled coils obtained after pickling is good. It can be seen that the thickness of the hot rolled coil of Examples 1-2 before acid tandem rolling is 3.00 mm, which is higher than the thickness of 2.50 mm in Comparative Examples 1-3, and the actual production efficiency of Examples 1-2 is high.

### Step 4

The chilled coil obtained in step 3 is subjected to final annealing in a continuous annealing furnace in a mixed atmosphere of H₂+N₂. During the final annealing, production is carried out at a constant speed throughout in Comparative Example 2 and Examples 1-2, and production is carried out at a reduced speed at the head and tail in Comparative Examples 1 and 3, hoping to eliminate the difference among the head, middle and tail as much as possible, where the annealing temperature fluctuates by ±10° C. That is, the difference between the maximum and minimum temperature values during final annealing does not exceed 20°.

The annealed steel strip is cooled, coated and finished to obtain the finished product of the non-oriented silicon steel. In the cooling process, three-stage cooling is used to cool the steel strip after the final annealing, effectively controlling the residual stress of the steel strip to be ≤50 MPa, which is beneficial for the control of plate shape.

The temperature for final annealing, the annealing time, the annealing rate, annealing time of head and tail and annealing rate of head and tail are shown in Table 4.

TABLE 4

| | | | | | Annealing |
|---|---|---|---|---|---|
| | Annealing | | | Annealing | rate of head |
| | temperature | Annealing | Annealing | time of head | and tail |
| | (° C.) | time (S) | rate (m/min) | and tail (S) | (m/min) |
| Comparative Example 1 | 900 | 55 | 150 | 61 | 135 |
| Comparative Example 2 | 900 | 55 | 150 | 55 | 150 |
| Comparative Example 3 | 950 | 55 | 150 | 61 | 135 |
| Example 1 | 850 | 55 | 150 | 55 | 150 |
| Example 2 | 850 | 55 | 150 | 55 | 150 |

The finished product of the non-oriented silicon steel obtained in Comparative Examples 1-3 and Examples 1 to 2 were tested. The magnetic properties and surface determination results are shown in Table 5.

TABLE 5

| | | | | | | | Fluctuation | Fluctuation of | |
|---|---|---|---|---|---|---|---|---|---|
| | | | | | | | of iron loss | magnetic | |
| | | | | | | | P_{1.5/50} | induction | |
| | Iron loss P_{1.5/50} | | | Magnetic induction | | | (W/kg) at | Intensity B₅₀₀₀ at | Surface |
| | (W/kg) | | | Intensity B₅₀₀₀ (T) | | | head, middle | head, middle and | quality |
| | Head | Middle | Tail | Head | Middle | Tail | and tail | tail (T) | determination |
| Comparative | 4.76 | 4.52 | 4.69 | 1.725 | 1.735 | 1.733 | 0.24 | 0.010 | Qualified |
| Example 1 | | | | | | | | | |
| Comparative | 4.10 | 4.02 | 4.08 | 1.743 | 1.741 | 1.736 | 0.08 | 0.007 | Unqualified |
| Example 2 | | | | | | | | | |
| Comparative | 4.02 | 3.88 | 4.05 | 1.709 | 1.720 | 1.711 | 0.17 | 0.011 | Qualified |
| Example 3 | | | | | | | | | |
| Example 1 | 3.95 | 3.98 | 4.03 | 1.730 | 1.739 | 1.738 | 0.08 | 0.005 | Qualified |
| Example 2 | 3.92 | 3.90 | 3.94 | 1.737 | 1.735 | 1.733 | 0.04 | 0.004 | Qualified |

As can be seen from Table 5: in Comparative Example 1 and Comparative Example 3, the normalizing process is not carried out, even if production is carried out at a reduced speed at the head and tail during the annealing, the difference between the magnetic properties of the head and tail and the middle cannot be completely eliminated; in Comparative Example 2 and Examples 1-2, the normalizing process is carried out, the production is carried out at a constant speed throughout during the annealing, the difference between the head and tail and the middle of the magnetic properties is small; but in Comparative Example 2, there is abnormal growth of grains on the surface during the normalizing, which results in that the surface quality of the finished product is determined to be inferior.

From the entire production, compared with Comparative Example 3, the Si and Mn element contents in Examples 1-2 are both greatly reduced and no Sn is added during the steelmaking (Sn contained in the finished product is inevitably introduced in molten iron or other alloys), i.e., the cost of steelmaking alloy is reduced. Moreover, the thickness of the hot rolled coil is increased, the speed of the hot rolling, the normalizing, acid tandem rolling is improved, the production cost is reduced. The production is carried out at a constant speed during the annealing, the production efficiency of the annealing process is improved, and the cost is reduced. In this way, in the case of low overall alloy costs and production costs, the finished product of the non-oriented silicon steel has low iron loss, small fluctuations of iron loss at the head, middle and tail, and substantially increased magnetic induction intensity B₅₀₀₀, and small fluctuation of magnetic induction intensity B₅₀₀₀ at the head, middle and tail.

In general, as can be seen from Examples 1-2 above, by using an embodiment of the present invention to produce the non-oriented silicon steel, the production efficiency is high, and the cost is low. Moreover, the magnetic properties of the resulting finished product of the non-oriented silicon steel are higher than those of the existing non-oriented silicon steel with the same Si content (e.g., the magnetic properties of the non-oriented silicon steels in Examples 1-2 with Si contents of 0.94% and 1.05% and without Sn are higher than those of the non-oriented silicon steel of Comparative Example 3 in the prior art with Si content of 1.54%+Sn content of 0.025%), and production is carried out at a constant speed during the annealing, and the consistency of magnetic properties at the head and tail is high.

What is claimed is:

1. A non-oriented silicon steel, comprising the following chemical composition in percentage by mass: C≤0.004%, S≤0.004%, Si: 0.8-1.1%, Mn: 0.2-0.4%, P≤0.03%, Nb≤0.004%, V≤0.006%, Ti≤0.005%, Cr≤0.03%, Ni≤0.03%, Cu≤0.03%, N≤0.004%, Al: 0.15-0.30% or Al≤0.02%, and the balance of Fe and unavoidable inclusions, wherein the non-oriented silicon steel has a thickness of 0.500±0.005 mm and is prepared by sequential steelmaking, billet casting, hot rolling, normalizing, acid tandem rolling, final annealing, cooling, coating and finishing:
Sn and Sb are not added in the steelmaking process;
in the hot rolling process: a cast billet obtained from the billet casting process is heated to 1060-1120° C. and held for 150 min or more, and then rolled into an intermediate billet with a thickness of 40-45 mm, and then the intermediate billet is finish rolled and coiled into a hot rolled coil with a thickness of 3.00±0.25 mm, wherein the start-rolling temperature for finish rolling is ≤Ar1=872° C.+1000*(11*[Si]−14*[Mn]+21*[Al]), in the formula, [Si], [Mn] and [Al] are mass percentages of Si, Mn and Al in the cast billet, respectively: the end-rolling temperature for finish rolling is ≤820° C., and the coiling temperature is ≤560° C.;
in the normalizing process, the normalizing temperature is 850-900° C.; and
in the final annealing process, the production is carried out at a constant speed and the annealing temperature is 820-880° C.

2. The non-oriented silicon steel according to claim 1, wherein the iron loss P_{1.5/50} thereof is ≤4.2 W/kg, the fluctuation of iron loss P_{1.5} so of the head, middle and tail is ≤0.2 W/kg, the magnetic induction intensity B₅₀₀₀ is ≥1.72 T and the fluctuation of magnetic induction intensity B₅₀₀₀ of the head, middle and tail is ≤0.02 T.

3. The non-oriented silicon steel according to claim 1, wherein in the normalizing process, the normalizing is carried out in a pure dry N₂ atmosphere for 120-150 s.

4. The non-oriented silicon steel according to claim 1, wherein in the normalizing process, the normalizing temperature fluctuates by ±10° C. and the production is carried out at a constant speed.

5. The non-oriented silicon steel according to claim 1, wherein in the annealing process, the annealing time is 50±5 s, the annealing temperature fluctuates by #10° C., and the production is carried out at a constant speed.

6. A method for producing a non-oriented silicon steel, comprising the following steps:
(1) carrying out steelmaking without the addition of Sn and Sb and preparing a cast billet, the cast billet comprising the following chemical composition in percentage by mass: C≤0.004%, S≤0.004%, Si: 0.8-1.1%, Mn: 0.2-0.4%, P≤0.03%, Nb≤0.004%, V≤0.006%, Ti≤ 0.005%, Cr≤0.03%, Ni≤0.03%, Cu≤0.03%, N≤0.004%, Al: 0.15-0.30% or Al≤0.02%, and the balance of Fe and unavoidable inclusions;
(2) heating the cast billet to 1060-1120° C. and holding for 150 min or more, then rolling the cast billet into an intermediate billet with a thickness of 40-45 mm, and then finish rolling and coiling the intermediate billet into a hot rolled coil with a thickness of 3.00±0.25 mm, wherein the start-rolling temperature for finish rolling is ≤ Ar1=872° C.+1000*(11*[Si]−14*[Mn]+21*[Al]), in the formula, [Si], [Mn] and [Al] are mass percentages of Si, Mn and Al in the cast billet, respectively: the end-rolling temperature for finish rolling is ≤820° C., and the coiling temperature is ≤560° C.;
(3) normalizing and acid tandem rolling the hot rolled coil in sequence to obtain a chilled coil with a thickness of 0.500±0.005 mm, wherein the normalizing temperature is 850-900° C.; and
(4) carrying out final annealing for the chilled coil in a continuous annealing furnace at a constant speed in a mixed atmosphere of H₂+N₂ at the temperature for final annealing of 820-880° C.; and cooling, coating and finishing the annealed steel strip to obtain the non-oriented silicon steel.

7. The method for producing a non-oriented silicon steel according to claim 6, wherein in step 3, the normalizing is carried out in a pure dry N₂ atmosphere for 120-150 s.

8. The method for producing a non-oriented silicon steel according to claim 6, wherein in step 3, the normalizing temperature fluctuates by ±10° C. and the production is carried out at a constant speed.

9. The method for producing a non-oriented silicon steel according to claim 6, wherein in step 4, the annealing time is 50±5 s, the annealing temperature fluctuates ±10° C., and the production is carried out at a constant speed.

10. The method for producing a non-oriented silicon steel according to claim 6, wherein the iron loss P_{1.5/50} of the non-oriented silicon steel is ≤4.2 W/kg, the fluctuation of iron loss P_{1.5/50} of the head, middle and tail is ≤0.2 W/kg, the magnetic induction intensity B₅₀₀₀ is ≥1.72 T and the fluctuation of magnetic induction intensity B₅₀₀₀ of the head, middle and tail is ≤0.02 T.

11. A method for producing a non-oriented silicon steel, comprising the following steps:
(1) carrying out steelmaking in accordance with a chemical composition of 0.8-1.1% of Si in percentage by mass and 0.2-0.4% of Mn in percentage by mass, without adding Sn and Sb during the steelmaking, and preparing a cast billet;
(2) heating the cast billet to 1060-1120° C. and holding for 150 min or more, then rolling the cast billet into an intermediate billet with a thickness of 40-45 mm, and then finish rolling and coiling the intermediate billet into a hot rolled coil with a thickness of 3.00±0.25 mm, wherein the start-rolling temperature for finish rolling is ≤Ar1=872° C.±1000*(11*[Si]−14*[Mn]+21*[Al]), in the formula, [Si], [Mn] and [Al] are mass percentages of Si, Mn and Al in the cast billet, respectively; the end-rolling temperature for finish rolling is ≤820° C., and the coiling temperature is ≤560° C.;
(3) normalizing and acid tandem rolling the hot rolled coil in sequence to obtain a chilled coil with a thickness of 0.500±0.005 mm, wherein the normalizing temperature is 850-900° C.; and
(4) carrying out final annealing for the chilled coil in a continuous annealing furnace at a constant speed in a mixed atmosphere of H₂+N₂ at the temperature for final annealing of 820-880° C.; and cooling, coating and finishing the annealed steel strip to obtain the non-oriented silicon steel.
